(19) United States
(12) Patent Application Publication
(10) Pub. No.: US 2013/0063685 A1
(43) Pub. Date: Mar. 14, 2013

(54) 3D DISPLAY PANEL AND METHOD FOR MANUFACTURING THE SAME

(71) Applicants: Chia-Chiang Hsiao, Shenzhen (CN); Chih-Wen Chen, Shenzhen (CN); Chengming He, Shenzhen (CN)

(72) Inventors: Chia-Chiang Hsiao, Shenzhen (CN); Chih-Wen Chen, Shenzhen (CN); Chengming He, Shenzhen (CN)

(73) Assignee: SHENZHEN CHINA STAR OPTOELECTRONICS TECHNOLOGY CO., LTD., Shenzhen (CN)

(21) Appl. No.: 13/375,544

(22) PCT Filed: Sep. 21, 2011
(86) PCT No.: PCT/CN11/79918

§ 371 Date: Dec. 1, 2011

(30) Foreign Application Priority Data
Sep. 9, 2011 (CN) 201110267005.7

(51) Int. Cl. G02F 1/1335; C08J 7/04; G02B 1/10

(52) U.S. Cl. 349/96; 427/163.1; 427/510

(57) ABSTRACT

The present invention provides a 3D display panel and a method for manufacturing the same. The method comprises the following steps: forming a liquid crystal layer between a first substrate and a second substrate; arranging a first polarizer at an outer side of the first substrate; arranging a second polarizer at an outer side of the second substrate; arranging a quarter wave layer, a half wave layer, an alignment layer and a cover substrate at an outer side of the first polarizer in sequence. The 3D display panel of the present invention is capable of displaying 3D images.

### FIELD OF THE INVENTION

The present invention relates to a display panel and a method for manufacturing the same, and more particularly to a three-dimensional (3D) display panel for displaying 3D images and a method for manufacturing the same.

### BACKGROUND OF THE INVENTION

Liquid crystal displays (LCDs) have been widely applied in electrical products. Currently, most of LCDs are backlight type LCDs which include a liquid crystal panel and a backlight module.

At present, the LCDs are capable of having a 3D image displaying function, such as a 3D pattern retarder display which has a quarter (¼) wave plate being disposed at an outer side of an LCD.

In general, the pattern retarder display has left image pixels and right image pixels. The left image pixels are positioned at odd pixel rows (or even pixel rows) of the display, and the right image pixels are positioned at the other pixel rows thereof. When the light of the display passes through the quarter-wave phase retarders with different orientations, the light is transformed into a left handed circularly polarized light and a right handed circularly polarized light, respectively. A user can use circular polarizer glasses with different polarized directions such that the user's left eye only sees images of the left image pixels, and the user's right eye only sees images of the right image pixels. Therefore, the 3D image effect of the display is achieved.

However, the technique of the 3D display is not perfect yet, and is still required to be improved.

### SUMMARY OF THE INVENTION

The present invention provides a 3D display panel and a method for manufacturing the same, so as to develop the 3D display technique.

A primary object of the present invention is to provide a 3D display panel, and the 3D display panel comprises: a first substrate; a second substrate; a liquid crystal layer formed between the first substrate and the second substrate; a first polarizer disposed at an outer side of the first substrate; a second polarizer disposed at an outer side of the second substrate; a quarter wave layer disposed at an outer side of the first polarizer; a half wave layer disposed at an outer side of the quarter wave layer; an alignment layer disposed at an outer side of the half wave layer; and a cover substrate disposed at an outer side of the alignment layer.

In one embodiment of the present invention, the cover substrate is a cover lens which is made of a material of high strength.

In one embodiment of the present invention, the half wave plate includes a plurality of half wave rows and a plurality of isotropic material rows, and the half wave rows are alternately arranged with the isotropic material rows.

Another object of the present invention is to provide a method for manufacturing a 3D display panel, and the method comprises the following steps: forming a liquid crystal layer between a first substrate and a second substrate; arranging a first polarizer at an outer side of the first substrate; arranging a second polarizer at an outer side of the second substrate; forming an alignment layer on a cover substrate; forming a half wave layer on the alignment layer; forming a quarter wave layer on the half wave layer; and arranging the quarter wave layer, the half wave layer, the alignment layer and the cover substrate at an outer side of the first polarizer in sequence.

In one embodiment of the present invention, the step of forming the half wave layer comprises: coating a half wave liquid crystal layer on the alignment layer; and patterning the half wave liquid crystal layer to form the half wave layer having a plurality of half wave rows and a plurality of isotropic material rows.

In one embodiment of the present invention, the step of patterning the half wave liquid crystal layer comprises: using a mask to expose the half wave liquid crystal layer to light, so as to allow portions of the half wave liquid crystal layer being emitted by the light to form the half wave rows, and to allow other portions of the half wave liquid crystal layer which are not emitted by the light to form the isotropic material rows.

In one embodiment of the present invention, the step of forming the half wave layer further comprises: baking the patterned half wave liquid crystal layer.

In one embodiment of the present invention, the step of forming the quarter wave layer comprises: coating a quarter wave liquid crystal layer on the half wave layer; and baking the quarter wave liquid crystal layer to form the quarter wave layer.

Still another object of the present invention is to provide a method for manufacturing a 3D display panel, and the method comprises the following steps: forming a liquid crystal layer between a first substrate and a second substrate; arranging a first polarizer at an outer side of the first substrate; arranging a second polarizer at an outer side of the second substrate; forming an alignment layer on a cover substrate; forming a half (½) wave layer on the alignment layer; forming a quarter (¼) wave layer on the half wave layer; and arranging the quarter wave layer, the half wave layer, the alignment layer and the cover substrate at an outer side of the first polarizer in sequence, wherein the alignment layer, the half wave layer and the quarter wave layer are first arranged on the cover substrate in sequence, and then the quarter wave layer, the half wave layer, the alignment layer and the cover substrate are assembled at the outer side of the first polarizer.

The 3D display panel of the present invention is capable of displaying 3D images. Furthermore, the 3D display panel and the method for manufacturing the same are different to the conventional 3D display, thus facilitating a development of the 3D display technique.

The structure and the technical means adopted by the present invention to achieve the above-mentioned and other objects can be best understood by referring to the following detailed description of the preferred embodiments and the accompanying drawings.

### DESCRIPTION OF THE DRAWINGS

FIG. 1 is a partially cross-sectional view showing a display apparatus comprising a 3D display panel according to a preferred embodiment of the present invention;

FIG. 2 is a flowchart of a method for manufacturing the 3D display panel according to the preferred embodiment of the present invention; and

FIGS. 3A-3G are schematic flow diagrams showing a process for manufacturing the 3D display panel according to the preferred embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

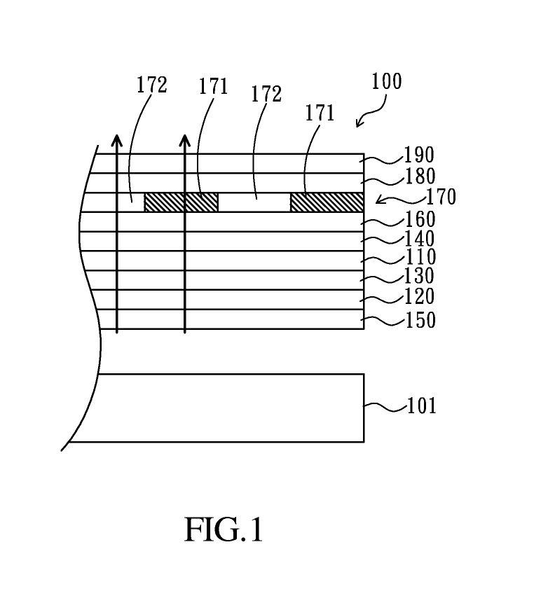

Referring to FIG. 1, a partially cross-sectional view showing a display apparatus comprising a 3D display panel according to an embodiment of the present invention is illustrated. The 3D display panel 100 of the present embodiment is capable of displaying 3D images. The 3D display panel 100 can be assembled with a backlight module 101, thereby forming a display apparatus. The 3D display panel 100 is disposed opposite to the backlight module 101, and the backlight module 101 may be realized as an edge lighting backlight module or a bottom lighting backlight module to provide the 3D display panel 100 with the back-light.

Referring to FIG. 1 again, the 3D display panel 100 of the present embodiment comprises a first substrate 110, a second substrate 120, a liquid crystal layer 130, a first polarizer 140, a second polarizer 150, a quarter (¼) wave layer 160, a half (½) wave layer 170, a alignment layer 180 and a cover substrate 190. The first substrate 110 and the second substrate 120 may be realized as glass substrates or flexible plastic substrates. In this embodiment, the first substrate 110 may be a glass substrate or other material substrates with color filters (CF), and the second substrate 120 may be a glass substrate or other material substrates with a thin film transistor (TFT) array. It should be noted that the CF and the TFT array may also be disposed on the same substrate in other embodiments.

Referring to FIG. 1 again, the liquid crystal layer 130 is formed between the first substrate 110 and the second substrate 120. The first polarizer 140 is disposed on an outer side of the first substrate 110, and the second polarizer 150 is disposed on an outer side of the second substrate 120. The quarter wave layer 160 is disposed at an outer side of the first polarizer 140. The half wave layer 170 is disposed at an outer side of the quarter wave layer 160. The alignment layer 180 is disposed at an outer side of the half wave layer 170. The cover substrate 190 is disposed at an outer side of the alignment layer 180. The cover substrate 190 is, for example, a cover lens which is preferably made of a material of high strength, such as glass, carbon fiber, reinforced plastics or any combination thereof, for protecting and packaging the structure of the 3D display panel 100.

Referring to FIG. 1 again, the half wave layer 170 includes a plurality of half wave rows 171 and a plurality of isotropic material rows 172. The half wave rows 171 are alternately arranged with the isotropic material rows 172, and a predetermined interval (e.g. a width of the isotropic material row 172) is between each two of the adjacent half wave rows 171. The half wave rows 171 have a characteristic of a normal half wave phase retarder for transforming a linearly polarized light into a circularly polarized light and improving the chromatic dispersion problem.

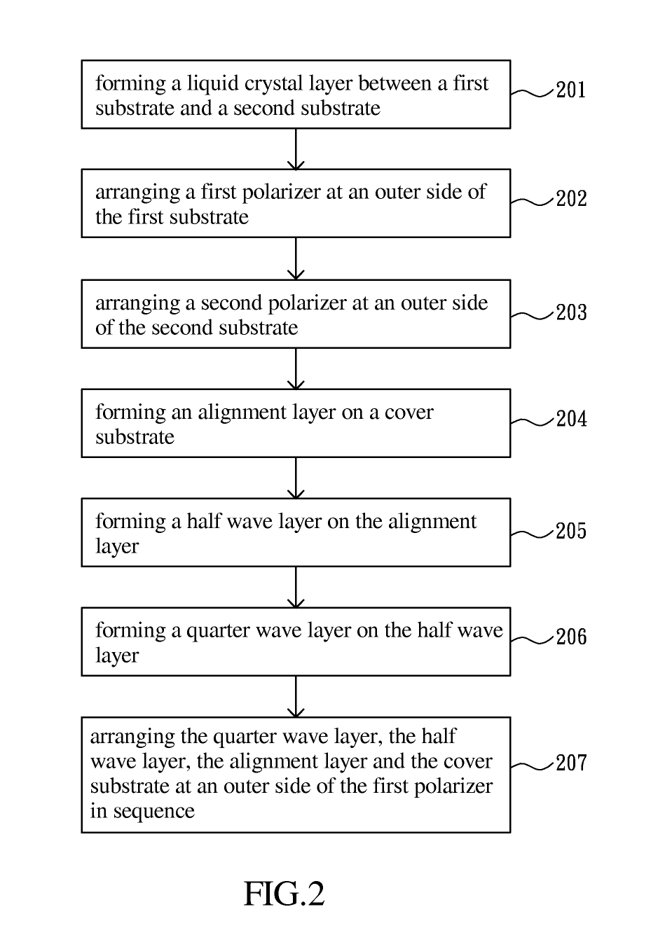

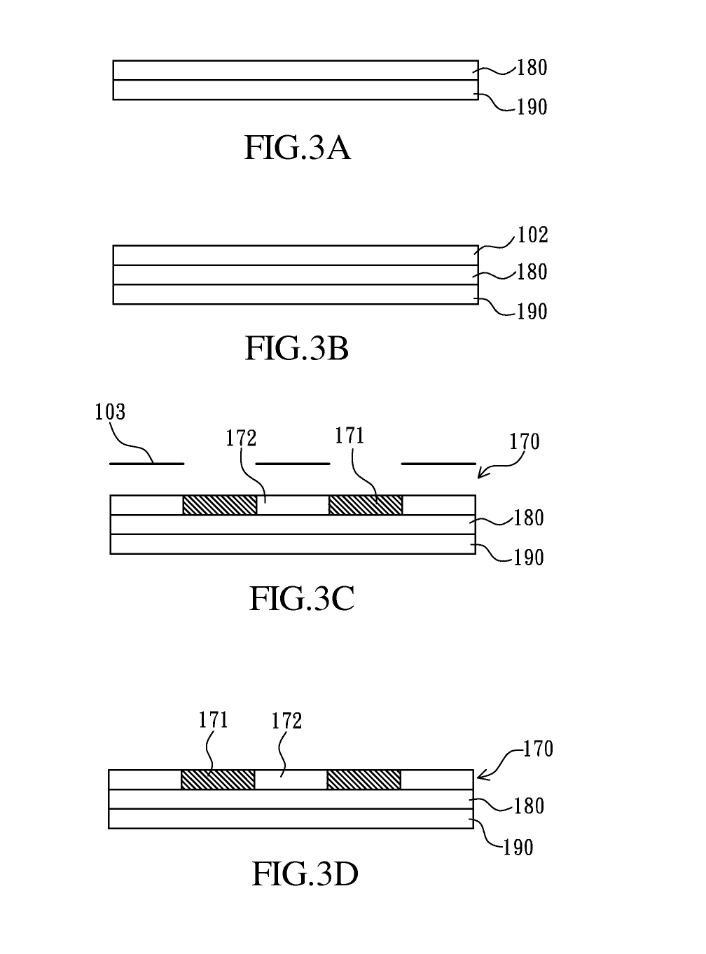

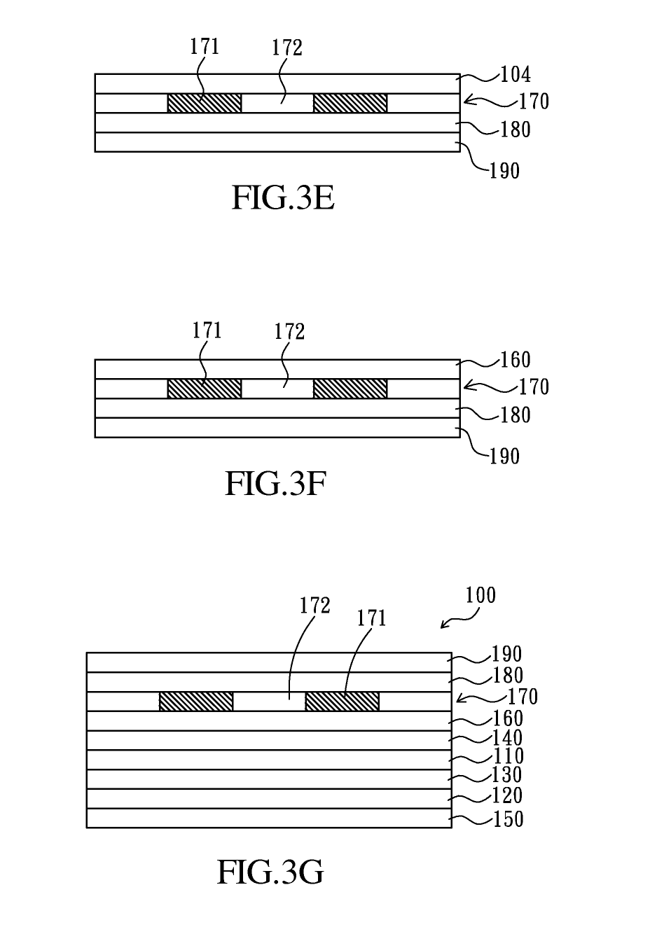

Referring to FIG. 2 and FIG. 3A through FIG. 3G, FIG. 2 is a flowchart of a method for manufacturing the 3D display panel according to an embodiment of the present invention, and FIGS. 3A-3G are schematic flow diagrams showing a process for manufacturing the 3D display panel according to an embodiment of the present invention. The method of the present invention for manufacturing the 3D display panel comprises the following steps: forming the liquid crystal layer 130 between the first substrate 110 and the second substrate 120 (step 201); arranging the first polarizer 140 at the outer side of the first substrate 110 (step 202); arranging the second polarizer 150 at the outer side of the second substrate 120 (step 203); forming the alignment layer 180 on the cover substrate 190 (step 204); forming the half wave layer 170 on the alignment layer 180 (step 205); forming the quarter wave layer 160 on the half wave layer 170 (step 206); and arranging the quarter wave layer 160, the half wave layer 170, the alignment layer 180 and the cover substrate 190 at the outer side of the first polarizer 140 in sequence (step 207).

In the step 204 of the present embodiment, when forming the alignment layer 180 on the cover substrate 190, the cover substrate 190 is provided, and a surface of the cover substrate 190 is cleaned. Subsequently, referring to FIG. 3A again, for example, a polyimide (PI) layer is coated on the surface of the cover substrate 190, and then the PI layer is aligned to form the alignment layer 180. In this case, the PI layer may be aligned by rubbing alignment, photo-alignment, ion beam alignment, plasma beam alignment.

In the step 205 of the present embodiment, when forming the half wave layer 170 on the alignment layer 180, referring to FIG. 3B again, a half wave (π/2) liquid crystal layer 102 is coated on the alignment layer 180, and then the λ/2 liquid crystal layer 102 is patterned to form the half wave layer 170 having the half wave rows 171 and the isotropic material rows 172. When patterning the λ/2 liquid crystal layer 102, referring to FIG. 3C again, a mask is used to expose the λ/2 liquid crystal layer 102 to light, so as to allow portions of the λ/2 liquid crystal layer 102 being emitted by the light to form the half wave rows 171, and other portions of the λ/2 liquid crystal layer 102 which are not emitted by the light are transformed to form the isotropic material rows 172. Subsequently, referring to FIG. 3D again, the patterned half wave layer 170 is baked for curing.

In the step 206 of the present embodiment, when forming the quarter wave layer 160 on the half wave layer 170, the half wave layer 170 is first aligned, and then a quarter wave (λ/4) liquid crystal layer 104 is coated on the half wave layer 170 (referring to FIG. 3E), and then the λ/4 liquid crystal layer 104 is baked to form the quarter wave layer 160 (referring to FIG. 3F).

In the step 207 of the present embodiment, the alignment layer 180, the half wave layer 170 and the quarter wave layer 160 are first arranged on the cover substrate 190 in sequence, and the quarter wave layer 160, the half wave layer 170, the alignment layer 180 and the cover substrate 190 are assembled at the outer side of the first polarizer 140 of the liquid crystal display panel, thereby achieving the 3D display panel 100 (referring to FIG. 3G), wherein the liquid crystal display panel is composed of the first substrate 110, the second substrate 120, the liquid crystal layer 130, the first polarizer 140 and the second polarizer 150. In the assembled 3D display panel 100, the quarter wave layer 160 faces to the first polarizer 140.

When a user views the 3D images of the 3D display panel 100 of the present embodiment, polarizer glasses can be used to cooperate with the 3D display panel 100 for forming a 3D image effect. At this time, a linearly polarized light emitted from the first polarizer 140 can be transformed into the left handed circularly polarized light or the right handed circularly polarized light by the quarter wave layer 160 and the half wave layer 170. Since the left handed circularly polarized light or the right handed circularly polarized light emitted from the 3D display panel 100 is only allowed to pass through one side (a right side or a left side) of the polarizer glasses. In other words, the user's eyes can view images of different pixel rows of the 3D display panel 100, respectively, thereby forming the 3D image effect.

As described above, the 3D display panel of the present invention can form a 3D image effect. Furthermore, the 3D display panel and the method for manufacturing the same are different to the conventional 3D display, thus facilitating a development of the 3D display technique.

The present invention has been described above with a preferred embodiment thereof, and it is understood that many changes and modifications to the described embodiment can be carried out without departing from the scope and the spirit of the invention that is intended to be limited only by the appended claims.

1. A method for manufacturing a three-dimensional (3D) display panel, characterized in that: the method comprises the following steps:
forming a liquid crystal layer between a first substrate and a second substrate;
arranging a first polarizer at an outer side of the first substrate;
arranging a second polarizer at an outer side of the second substrate;
forming an alignment layer on a cover substrate;
forming a half (½) wave layer on the alignment layer;
forming a quarter (¼) wave layer on the half wave layer; and
arranging the quarter wave layer, the half wave layer, the alignment layer and the cover substrate at an outer side of the first polarizer in sequence, wherein the alignment layer, the half wave layer and the quarter wave layer are first arranged on the cover substrate in sequence, and then the quarter wave layer, the half wave layer, the alignment layer and the cover substrate are assembled at the outer side of the first polarizer.

2. The method according to claim 1, characterized in that: the step of forming the half wave layer comprises:
coating a half wave liquid crystal layer on the alignment layer; and
patterning the half wave liquid crystal layer to form the half wave layer having a plurality of half wave rows and a plurality of isotropic material rows.

3. The method according to claim 2, characterized in that: the step of patterning the half wave liquid crystal layer comprises:
using a mask to expose the half wave liquid crystal layer to light, so as to allow portions of the half wave liquid crystal layer being emitted by the light to form the half wave rows, and to allow other portions of the half wave liquid crystal layer which are not emitted by the light to form the isotropic material rows.

4. The method according to claim 2, characterized in that: the step of forming the half wave layer further comprises:
baking the patterned half wave liquid crystal layer.

5. The method according to claim 1, characterized in that: the step of forming the quarter wave layer comprises:
coating a quarter wave liquid crystal layer on the half wave layer; and
baking the quarter wave liquid crystal layer to form the quarter wave layer.

6. A 3D display panel, characterized in that: the 3D display panel comprises:
a first substrate;
a second substrate;
a liquid crystal layer formed between the first substrate and the second substrate;
a first polarizer disposed at an outer side of the first substrate;
a second polarizer disposed at an outer side of the second substrate;
a quarter wave layer disposed at an outer side of the first polarizer;
a half wave layer disposed at an outer side of the quarter wave layer;
an alignment layer disposed at an outer side of the half wave layer; and
a cover substrate disposed at an outer side of the alignment layer.

7. The 3D display panel according to claim 6, characterized in that: the cover substrate is a cover lens which is made of a material of high strength.

8. The 3D display panel according to claim 6, characterized in that: the half wave plate includes a plurality of half wave rows and a plurality of isotropic material rows, and the half wave rows are alternately arranged with the isotropic material rows.

9. A method for manufacturing a 3D display panel, characterized in that: the method comprises the following steps:
forming a liquid crystal layer between a first substrate and a second substrate;
arranging a first polarizer at an outer side of the first substrate;
arranging a second polarizer at an outer side of the second substrate;
forming an alignment layer on a cover substrate;
forming a half wave layer on the alignment layer;
forming a quarter wave layer on the half wave layer; and
arranging the quarter wave layer, the half wave layer, the alignment layer and the cover substrate at an outer side of the first polarizer in sequence.

10. The method according to claim 9, characterized in that: the step of forming the half wave layer comprises:
coating a half wave liquid crystal layer on the alignment layer; and
patterning the half wave liquid crystal layer to form the half wave layer having a plurality of half wave rows and a plurality of isotropic material rows.

11. The method according to claim 10, characterized in that: the step of patterning the half wave liquid crystal layer comprises:
using a mask to expose the half wave liquid crystal layer to light, so as to allow portions of the half wave liquid crystal layer being emitted by the light to form the half wave rows, and to allow other portions of the half wave liquid crystal layer which are not emitted by the light to form the isotropic material rows.

12. The method according to claim 11, characterized in that: the step of forming the half wave layer further comprises:
baking the patterned half wave liquid crystal layer.

13. The method according to claim 10, characterized in that: the step of forming the quarter wave layer comprises:
coating a quarter wave liquid crystal layer on the half wave layer; and
baking the quarter wave liquid crystal layer to form the quarter wave layer.
